(19) United States
(12) Patent Application Publication
(10) Pub. No.: US 2007/0216303 A1
(43) Pub. Date: Sep. 20, 2007

(54) Plasma display panel

(76) Inventors: Soo-ho Park, Suwon-si (KR); Won-Ju Yi, Suwon-si (KR); Ho-Young Ahn, Suwon-si (KR); Kyoung-Doo Kang, Suwon-si (KR); Dong-Young Lee, Suwon-si (KR); Seok-Gyun Woo, Suwon-si (KR); Jae-Ik Kwon, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/712,505

(22) Filed: Mar. 1, 2007

(30) Foreign Application Priority Data
Mar. 2, 2006 (KR) 10-2006-0019924

(51) Int. Cl. H01J 17/49

(52) U.S. Cl. 313/582; 313/584; 313/583

(57) ABSTRACT

A plasma display panel (PDP) may include a first substrate, a second substrate spaced apart from the first substrate, a barrier rib interposed between the first and second substrates, the barrier rib including passages there through defining discharge cells, barrier rib electrodes including discharge parts adjacent the discharge cells and inside the barrier rib, contact parts arranged on a surface of the barrier rib and having round cross-sections, and intermediate parts connecting the discharge parts to the contact parts, terminal electrodes each having one end electrically connected to the contact parts and another end electrically connected to a signal transmitting member, phosphor in the discharge cells and a discharge gas in the discharge cells.

### BACKGROUND OF THE INVENTION

1. Field of the Invention

The present invention relates to a plasma display panel (PDP). More particularly, the present invention relates to a PDP that electrically connects barrier electrodes and terminal electrodes in a stable manner.

2. Description of the Related Art

Plasma display panels (PDPs) display desired images using a gas discharge phenomenon. A conventional plasma display device may include a PDP having a front substrate and a rear substrate that face each other and are spaced apart by a predetermined gap. Between the front and rear substrates, the PDP may include barriers defining a discharge cell disposed between the first and second substrates, a discharge gas filling the discharge cell, a phosphor coating the surface of the discharge cell, and a plurality of electrodes. When a discharge voltage is applied to the electrodes, the discharge occurs in the discharge cell, causing the discharge gas to emit ultraviolet light, thereby exciting the phosphor to emit visible light, thus forming an image. The plasma display device may also include a circuit substrate that operates the PDP.

The electrodes that receive discharge voltages from outside and perform a discharge are electrically connected to terminal electrodes arranged on one of the front and rear substrates. These terminal electrodes, in turn, receive discharge voltages from signal transfer members.

However, electrodes that perform the discharge are usually arranged inside the barriers to ensure discharge efficiency. In this case, since barrier electrodes arranged inside the barriers and terminal electrodes arranged on the substrates may be at different heights, the barrier electrodes and the terminal electrodes may not easily connected to each other. Such a problem may cause a failure in assembling and operating the PDP. To address the problem, a PDP having an appropriate electrode connection structure must be developed.

### SUMMARY OF THE INVENTION

The present invention is therefore directed to a plasma display panel (PDP) that substantially overcomes one or more the problems of the related art.

It is a feature of an embodiment of the present invention to provide a PDP that electrically connects barrier electrodes arranged inside barrier ribs and terminal electrodes arranged on substrates in a stable manner.

At least one of the above and other features and advantages of the present invention may be realized by providing a plasma display panel (PDP) including a first substrate, a second substrate spaced apart from the first substrate, a barrier rib interposed between the first and second substrates, the barrier rib including passages there through defining discharge cells, barrier rib electrodes including discharge parts adjacent the discharge cells and inside the barrier rib, contact parts arranged on a surface of the barrier rib and having round cross-sections, and intermediate parts connecting the discharge parts to the contact parts, terminal electrodes each having one end electrically connected to the contact parts and another end electrically connected to a signal transmitting member, phosphor in the discharge cells, and a discharge gas in the discharge cells.

The barrier rib may have a sheet structure. The barrier rib may be made of a dielectric material. Surfaces of passages in the barrier rib may be covered by a protective layer. The discharge parts may surround at least a part of each of the discharge cells. The discharge parts may be stripe-shaped. The discharge parts may completely surround each of the discharge cells. The terminal electrodes may be arranged on a surface of one of the first and second substrates closest to the contact parts.

The barrier rib may include a first barrier rib and a second barrier rib, the first and second barrier ribs defining the discharge cells. The phosphor may be on surfaces of at least one of the first and second barrier ribs defining the discharge cell.

The PDP may further include a dummy barrier rib adjacent the second barrier rib, and connection electrodes on the dummy barrier rib, the contact parts being electrically connected to the terminal electrodes through the connection electrodes. The dummy barrier rib may include grooves, the connection electrodes being arranged in the grooves. The second barrier rib and the dummy barrier rib may be on the second substrate. An interior surface of the second substrate may serve as base parts of the grooves. A length of the groove may substantially equal a width of the dummy barrier rib. The connection electrodes may be arranged to surround parts of the grooves of the dummy barrier rib.

The signal transmitting member may include a plurality of conductive wires. The signal transmitting member may be a flexible printed cable. The signal transmitting member may be a tape carrier package. The conductive wires of the signal transmitting member may be secured to the terminal electrodes using an anisotropic conductive film.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partially exploded perspective view of a plasma display panel (PDP) according to an embodiment of the present invention;

FIG. 2 illustrates a cross-sectional view of the PDP of FIG. 1 taken along a line II-II in FIG. 1;

FIG. 3 illustrates a cross-sectional view of the PDP of FIG. 1 taken along a line III-III in FIG. 2;

FIG. 4 illustrates a perspective view of connection electrodes arranged in grooves of a dummy barrier rib according to an embodiment of the present invention;

FIG. 5 schematically illustrates a perspective view of an arrangement of discharge parts of barrier rib electrodes and discharge cells of the PDP illustrated in FIG. 1;

FIG. 6 illustrates a cross-sectional view of projections formed on the rectilinear upper and lower surfaces of a first barrier rib on which barrier rib electrodes are arranged;

FIG. 7 illustrates a partially exploded perspective view of a PDP according to another embodiment of the present invention;

FIG. 8 illustrates a cross-sectional view of the PDP of FIG. 7 taken along a line VIII-VIII in FIG. 7;

FIG. 9 illustrates a cross-sectional view of the PDP of FIG. 7 taken along a line IX-IX in FIG. 8; and

FIG. 10 schematically illustrates a perspective view of an arrangement of discharge parts of barrier rib electrodes and discharge cells of the PDP illustrated in FIG. 7.

### DETAILED DESCRIPTION OF THE INVENTION

Korean Patent Application No. 10-2006-0019924, filed on Mar. 2, 2006, in the Korean Intellectual Property Office, and entitled: “Plasma Display Panel (PDP),” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

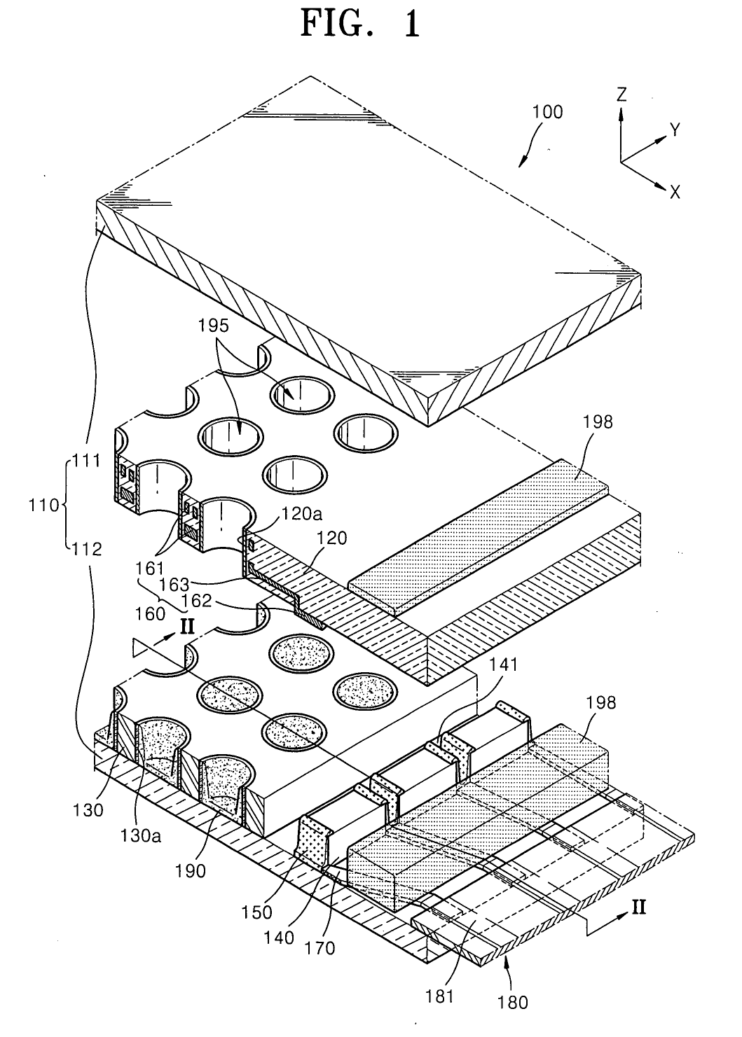

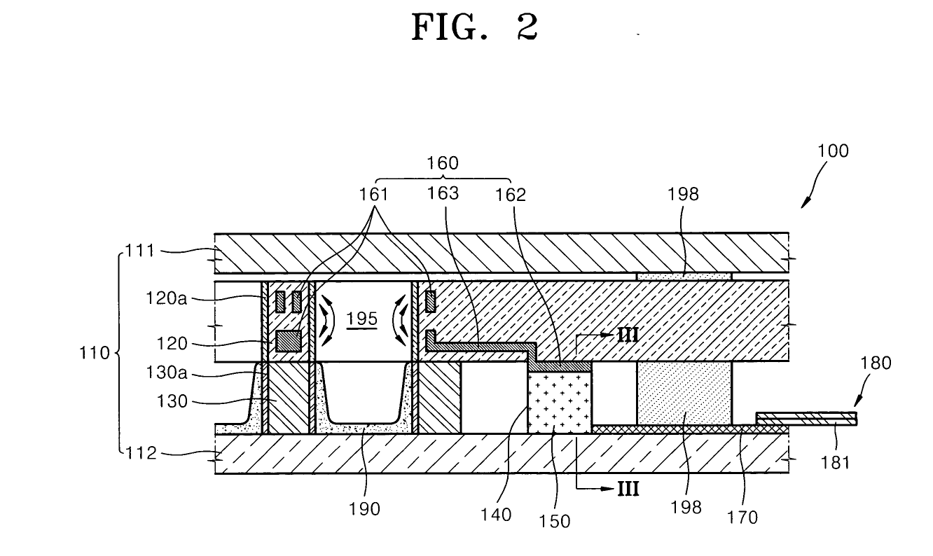

FIG. 1 illustrates a partially exploded perspective view of a plasma display panel (PDP) 100 according to an embodiment of the present invention. FIG. 2 illustrates a cross-sectional view of the PDP of FIG. 1 taken along a line II-II in FIG. 1. FIG. 3 illustrates a cross-sectional view of the PDP of FIG. 1 taken along a line III-III in FIG. 2.

Referring to FIGS. 1 and 2, the PDP 100 may include a pair of substrates 110, a first barrier rib 120, a second barrier rib 130, a dummy barrier rib 140, connection electrodes 150, barrier rib electrodes 160, terminal electrodes 170, a signal transmitting member 180, and phosphor layers 190.

The pair of substrates 110 may include a first substrate 111 and a second substrate 112, which may be spaced apart from each other by a predetermined gap and face each other. The first substrate 111 may be transparent, e.g., may be made of glass through which visible light is transmitted. A frit 198 may be disposed between the first substrate 111 and the first barrier rib 120 and between the second substrate 112 and the first barrier rib 120, and may seal the PDP 100, e.g., using a baking process. After the PDP 100 is sealed, a discharge gas, e.g., Ne, Xe, or a mixture thereof, may fill the PDP 100.

In the current embodiment, since the first substrate 111 is transparent, visible light generated by a discharge may be transmitted through the first substrate 111, but the present invention is not necessarily restricted thereto. In detail, when the first substrate 111 is formed of an opaque material, the second substrate 112 may be formed of a transparent material, or the first and second substrates 111 and 112 may both be formed of a transparent material. Also, the first and second substrates 111 and 112 may be formed of a translucent material and may include a color filter.

The first barrier rib 120 may be interposed between the first and second substrates 111 and 112. The first barrier rib 120, the pair of substrates 110, and the second barrier rib 130 may partition discharge cells 195 in which discharge is generated. The barrier rib electrodes 160 may be arranged in the first barrier rib 120. The barrier rib electrodes 160 may include discharge parts 161, contact parts 162, and intermediate parts 163. The discharge parts 161 may be arranged inside the first barrier rib 120 to perform a discharge and surround the discharge cells 195. The intermediate parts 163 may electrically connect the discharge parts 161 and the contact parts 162, and may be arranged inside the first barrier rib 120.

The first barrier rib 120 may be formed of a dielectric to prevent the barrier rib electrodes 160 from sending a current therebetween when a sustain discharge is generated, and may prevent the barrier rib electrodes 160 from being damaged due to collisions between charged particles and the barrier rib electrodes 160, thereby accumulating wall charges by inducing charged particles. The dielectric may be PbO, B₂O₃, SiO₂, etc.

The first barrier rib 120 may have a dielectric sheet structure, and may be interposed between the first substrate 111 and the second substrate 112. In the plurality of dielectric sheets where the barrier rib electrodes 160 are arranged, a punching process may be performed whereby discharge spaces for the discharge cells 195 may be formed.

In the current embodiment, the first barrier rib 120 has the dielectric sheet structure but the present invention is not necessarily restricted thereto. In detail, the first barrier rib 120 may not have the sheet structure, but may be formed on the second barrier rib 130 using printing, etc., so that the first barrier rib 120 and the second barrier rib 130 may be integrally formed.

The second barrier rib 130 may be arranged on the second substrate 112. As described above, the pair of substrates 110, the first barrier rib 120, and the second barrier rib 130 may partition the discharge cells 195.

The second barrier rib 130 may be formed on the second substrate 112 using, e.g., printing, sand blasting, etc. The phosphor layers 190 may be arranged on the surfaces of the second barrier rib 130 facing the discharge cells 195.

In the current embodiment, the second barrier rib 130 does not have the sheet structure, but contacts the second substrate 112, but the present invention is not necessarily restricted thereto. In detail, the second barrier rib 130 may have the sheet structure and may be formed on the second substrate 112.

In the current embodiment, the first barrier rib 120 and the second barrier rib 130 partition the discharge cells 195 and partition display regions where an image is displayed, but the present invention is not necessarily restricted thereto. In detail, the first barrier rib 120 and the second barrier rib 130 may partition dummy cells where the image is not displayed. Dummy cells may not include an electrode or a phosphor layer and thus do not perform a discharge. In this case, the dummy cells may be formed between the discharge cells 195.

In the present embodiment, the discharge cells 195 partitioned by the first barrier rib 120 and the second barrier rib 130 may have circular cross-sections, but are not necessarily restricted thereto, and can have other cross-sectional shapes, e.g., triangular, tetragonal, octagonal, or oval.

Protective layers 120a and 130a may cover the sides of the first barrier rib 120 and the second barrier rib 130 facing the discharge cells 195, respectively. The protection layers 120a and 130a may be formed of magnesium oxide (MgO) and may prevent the first barrier rib 120 and the second barrier rib 130 formed of a dielectric substance from being damaged due to sputtering of plasma particles, discharge secondary electrons, and reduce a discharge voltage.

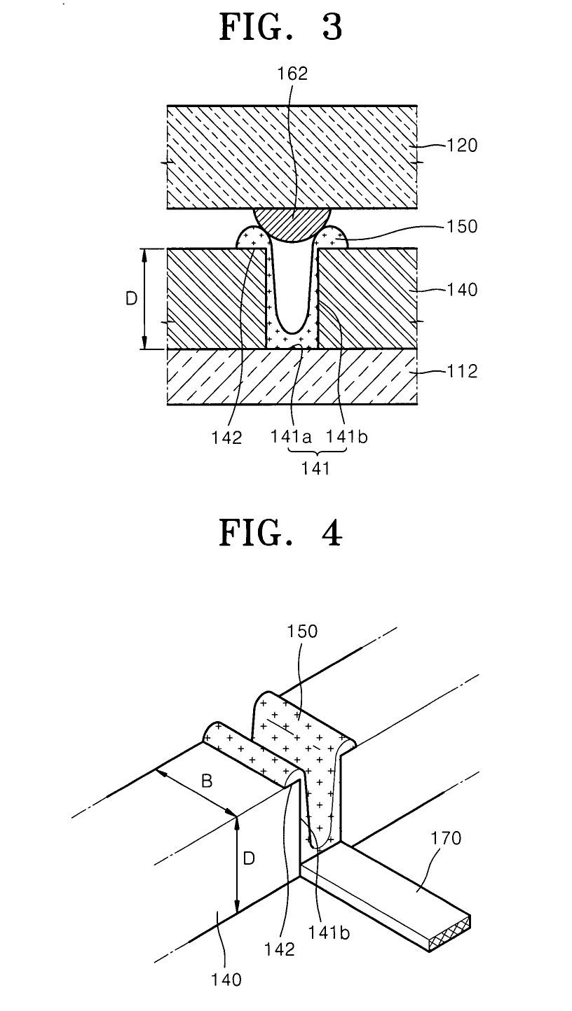

The dummy barrier rib 140 may be formed on the second substrate 112 and outside the second barrier rib 130. The dummy barrier rib 140 may protect the second barrier rib 130, and may include grooves 141 where the connection electrodes 150 are formed and thus the dummy barrier rib 140 electrically connects the barrier rib electrodes 160 and the terminal electrodes 170. The grooves 141 may be formed in the dummy barrier rib 140 to arrange the connection electrodes 150, as illustrated in FIGS. 3 and 4.

FIG. 4 illustrates a perspective view of the connection electrodes 150 arranged in the grooves 141 of the dummy barrier rib 140 according to an embodiment of the present invention

Referring to FIGS. 3 and 4, each of the grooves 141 may include a base part 141a and a side surface part 141b. In the present embodiment, the base part 141a may be formed on a portion of the inner surface of the second substrate 112.

In the present embodiment, a depth of the base part 141a may be identical to a height D of the dummy barrier rib 140 so that the base part 141a may be formed on the portion of the inner surface of the second substrate 112, but the present invention is not necessarily restricted thereto. That is, the depth of the base part 141a may be shorter than the height D of the dummy barrier rib 140. In this case, the connection electrodes 150 formed in the base part 141a may be electrically connected to the terminal electrodes 170. For example, a barrier rib material may be sufficiently coated so that the connection electrodes 150 in the base part 141a may be electrically connected to the terminal electrodes 170.

In the present embodiment, a length of the grooves 141 may be identical to a width B of the dummy barrier rib 140, but the present invention is not necessarily restricted thereto. That is, the length of the grooves 141 may be shorter than the width B of the dummy barrier rib 140.

The connection electrodes 150 may be arranged in the base part 141a, the side surface part 141b, and a surrounding part 142 of the grooves 141. The connection electrodes 150 may be formed by coating an electrode material in the form of a paste on the grooves 141 as illustrated in FIGS. 3 and 4, thereby electrically contacting contact parts 162 of the barrier rib electrodes 160.

More specifically, each contact part 162 may have a convex cross-section, e.g., having a round contact surface as illustrated, and may electrically contact a portion of a corresponding connection electrode 150 along an upper portion of the side surface part 141b and the surrounding part 142. That is, a convex portion of the contact part 162 may be inserted into the connection electrode 150 along the upper portion of the side surface part 141b and the surrounding part 142, so that the contact part 162 electrically contacts the connection electrode 150.

In the present embodiment, the connection electrodes 150 may be formed by partly filling the electrode material in the grooves 141 as illustrated in FIGS. 3 and 4, but the present invention is not necessarily restricted thereto. That is, the connection electrodes 150 may be formed by wholly filling the electrode material in the grooves 141. In this case, the connection electrodes 150 may electrically connect the contact parts 162 of the barrier rib electrodes 160 and the terminal electrodes 170.

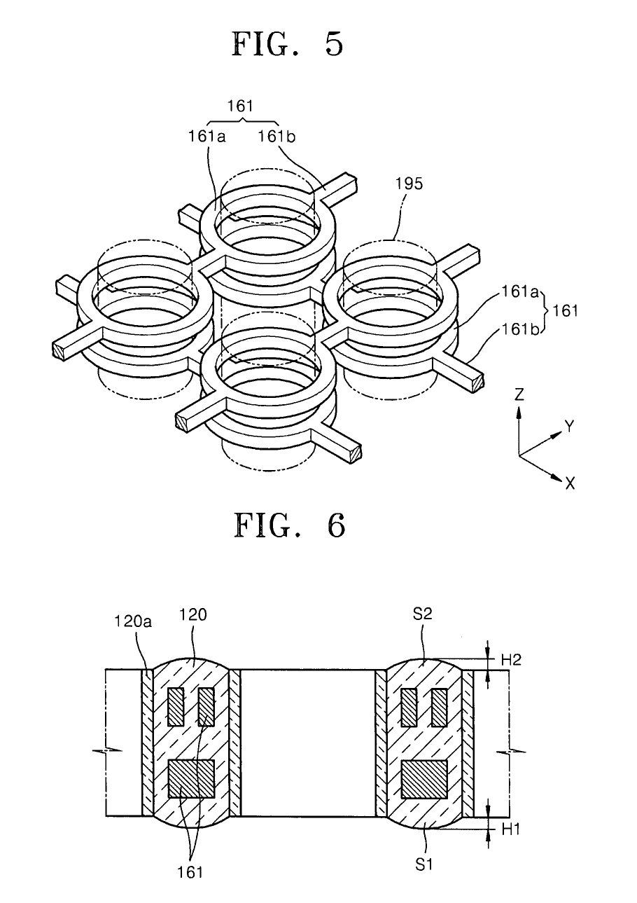

FIG. 5 illustrates a perspective schematic view of an arrangement of the discharge parts 161 of the barrier rib electrodes 160. Referring to FIG. 5, the discharge parts 161 may include loop parts 161a and loop connection parts 161b, and may surround the discharge cells 195.

In the present embodiment, the discharge parts 161 of the barrier rib electrodes 160 may include the circular loop parts 161a, but the present invention is not necessarily restricted thereto. That is, portions surrounding the discharge cells 195 of the discharge parts 161 may be any of a variety of shapes, e.g., an oval, a polygon, or “C” shape.

In the present embodiment, the discharge parts 161 of the barrier rib electrodes 160 surround the discharge cells 195 so that a sustain discharge may be generated in a perpendicular direction at every perimeter position of the discharge parts 161 partitioning the discharge cells 195, but the present invention is not necessarily restricted thereto. In detail, the discharge parts 161 may be stripe-shaped, and may be buried in barrier rib parts. In this case, the discharge parts 161 may have a discharge path of an opposite discharge than a surface discharge.

In the present embodiment, since the discharge parts 161 of the barrier rib electrodes 160 are arranged inside the first barrier rib 120, the discharge parts 161 do not need to be transparent, and may be formed of a conductive metal, e.g., Ag, Al, etc., such that the PDP may quickly respond to a discharge, does not distort a signal, and may reduce power consumption required for the sustain discharge.

In the present embodiment, the barrier rib electrodes 160 may perform an addressing function between pairs of symmetrical intersecting electrodes, but the present invention is not necessarily restricted thereto. In detail, the PDP of the present invention may include barrier rib electrodes that perform the addressing function to form a 3-electrode type PDP.

The terminal electrodes 170 may each have one end electrically connected to the connection electrodes 150 and another end electrically connected the signal transmitting member 180. The terminal electrodes 170 may be arranged on the second substrate 112.

In the present embodiment, the terminal electrodes 170 are arranged on the second substrate 112, but the present invention is not necessarily restricted thereto. That is, the terminal electrodes 170 may be arranged on the inner surface of the first substrate 111. In this case, the second barrier rib 130 and the dummy barrier rib 140 may be formed in the first substrate 111, and the contact parts 162 of the barrier rib electrodes 160 may be arranged on the upper part of the first barrier rib 120.

The signal transmitting member 180 may be electrically connected to an operating circuit substrate (not shown) that operates the PDP 100, and may be formed of a flexible printed cable (FPC) or a tape carrier package (TCP). The signal transmitting member 180 may include conductive wires 181 that transfer an electrical signal. The conductive wires 181 may be electrically connected to the terminal electrodes 170, and may be spaced apart from each other by a predetermined gap. The conductive wires 181 of the signal transmitting member 180 may be connected to the terminal electrodes 170, e.g., via an anisotropic conductive film.

The phosphor layers 190 may be formed on the surface of the second barrier rib 130 in accordance with the red, green, and blue discharge cells 195. The phosphor layers 190 may includes a phosphor for generating visible light in response to ultraviolet rays. That is, a phosphor layer formed in a red light emitting discharge cell may include a phosphor, e.g., Y(V,P)O₄:Eu, a phosphor layer formed in a green light emitting discharge cell may include a phosphor, e.g., Zn₂SiO₄:Mn, YBO₃:Tb, and a phosphor layer formed in a blue light emitting discharge cell may include a phosphor, e.g., BAM:Eu.

The phosphor layers 190 of the present embodiment may be formed on the surface of the second barrier rib 130, but the present invention is not necessarily restricted thereto. In detail, the phosphor layers 190 may be formed in any portions of the discharge cells 195, e.g., the surfaces of the first barrier rib 120, in order to discharge visible light in response to ultraviolet rays generated by a plasma discharge.

Functions and manufacturing operations of the PDP 100 according to the present embodiment will now be described in detail.

After the manufacturing of the PDP 100 and the injection of the discharge gas are complete, if an address voltage is applied between the discharge parts 161 of the barrier rib electrodes 160 from an external power source via the signal transmitting member 180, the terminal electrodes 170, the connection electrodes 150, and the contact parts 162, the address discharge may be generated. Thus, a discharge cell where a sustain discharge is to be generated may be selected from the discharge cells 195.

If a discharge sustain voltage is applied between the discharge parts 161 of the barrier rib electrodes 160 via the signal transmitting member 180, the terminal electrodes 170, the connection electrodes 150, and the contact parts 162, the sustain discharge may be generated due to movement of wall charges. An energy level of the discharge gas excited by the sustain discharge may be reduced, thereby discharging ultraviolet rays.

The ultraviolet rays may excite the phosphor layers 190 in the discharge cells 195. The energy level of the excited phosphor layers 190 may be reduced to discharge visible light. The discharged visible light may be transmitted through the first substrate 111 and may form an image to be recognized by a user.

The contact parts 162 having the convex cross-sections may contact the connection electrodes 150 to insure supply of the discharge sustain voltages to the discharge parts 161, thereby avoiding an erroneous connection between electrodes.

FIG. 6 illustrates a cross-sectional view of projections formed on the rectilinear upper and lower surfaces of a first barrier rib on which barrier rib electrodes are arranged. When the first barrier rib 120 has a sheet structure including stacked dielectric substances and electrodes, projections S1 and S2, having heights H1 and H2, may be formed on the rectilinear lower and upper surfaces, respectively, of the first barrier rib 120 in which the barrier rib electrodes 160 are arranged as illustrated in FIG. 6. However, the projection S2 may increase a gap between the first barrier rib 120 and the second barrier rib 130. Non the less, even when the projection S2 is present, since the contact parts 162 of the barrier rib electrodes 160 have convex cross sections, the contact parts 162 may still be pressed on the upper part of the connection electrodes 150 formed on the grooves 141 of the dummy barrier rib 140, thereby electrically contacting the contact parts 162 and the connection electrodes 150.

The discharge parts 161 of the barrier rib electrodes 160 may surround the discharge cells 195 so that the sustain discharge may be performed at every perimeter position of the discharge cells 195. Therefore, the PDP 100 of the present embodiment may have a relatively wide discharge area, thereby increasing light emitting brightness and light emitting efficiency.

Since the first barrier rib 120 of the PDP 100 may be formed of sheets and holes in a space where a discharge is to be generated, the manufacturing process may be simplified and the manufacturing costs may be reduced.

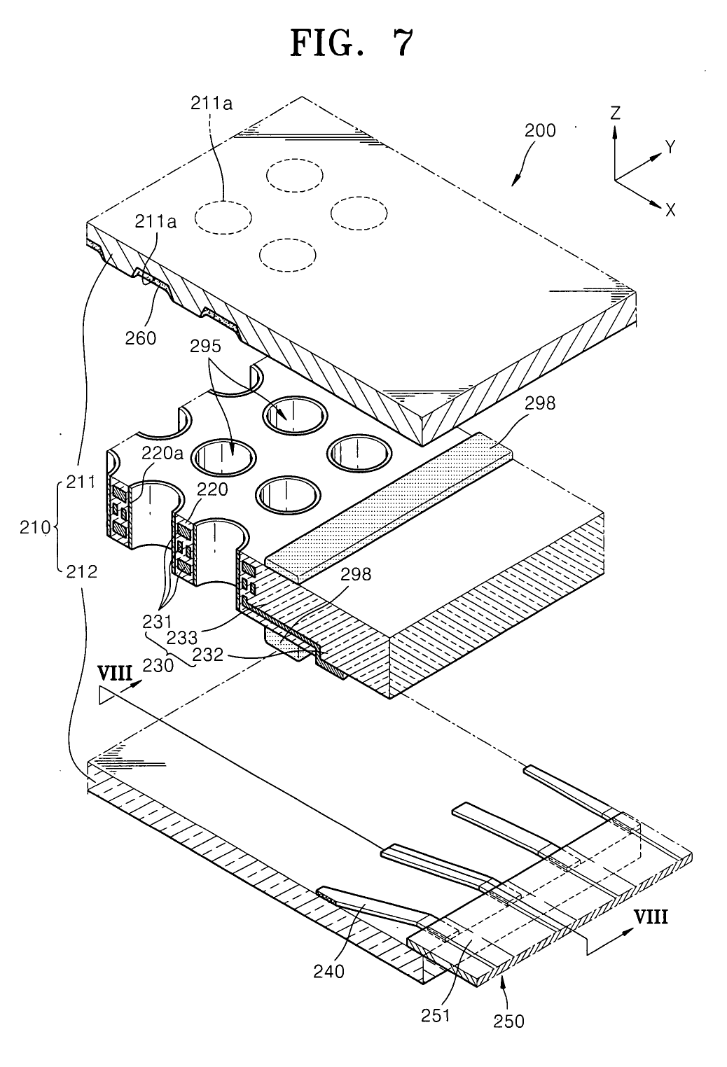

A PDP 200 according to another embodiment of the present invention will now be described with reference to FIGS. 7 through 9.

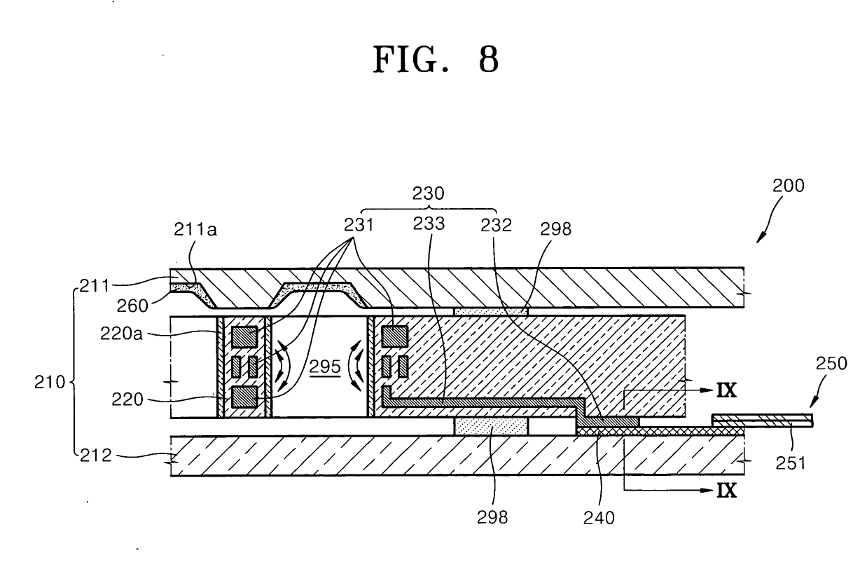

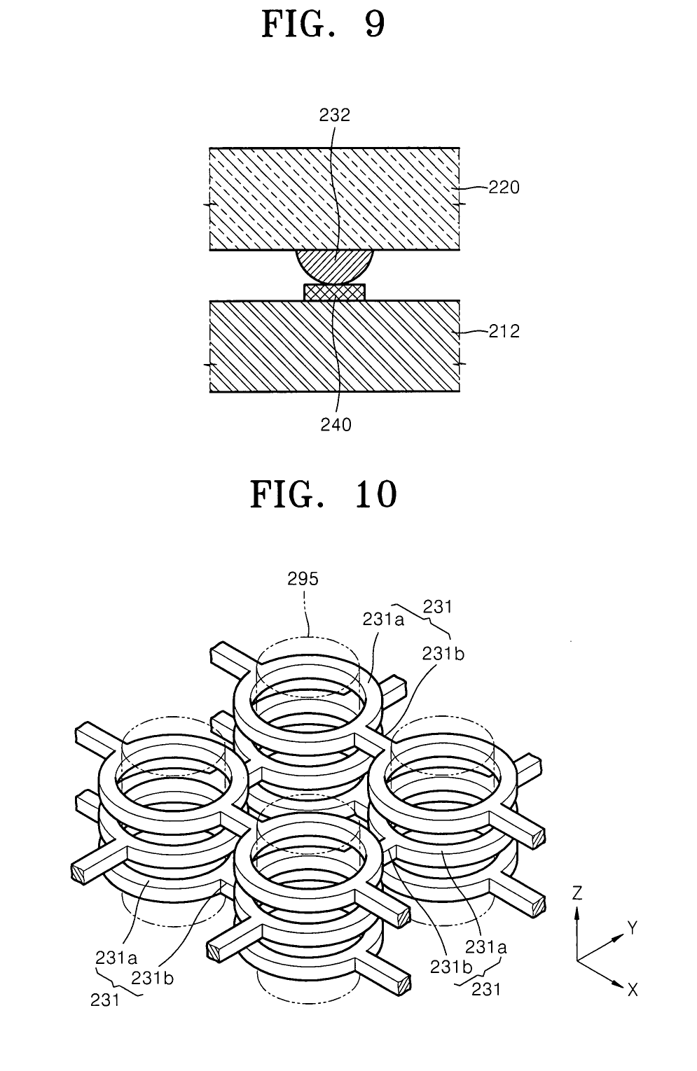

FIG. 7 illustrates a partially exploded perspective view of a PDP according to another embodiment of the present invention. FIG. 8 illustrates a cross-sectional view of the PDP of FIG. 7 taken along a line VIII-VIII in FIG. 7. FIG. 9 illustrates a cross-sectional view of the PDP of FIG. 7 taken along a line IX-IX in FIG. 8.

Referring to FIGS. 7 through 9, the PDP 200 may include a pair of substrates 210, a barrier rib 220, barrier rib electrodes 230, terminal electrodes 240, a signal transmitting member 250, and phosphor layers 260.

The pair of substrates 210 may include a first substrate 211 and a second substrate 212 which are spaced apart from each other by a predetermined gap and face each other. The first substrate 211 may be transparent, e.g., may be made of glass through which a visible light is transmitted.

The barrier rib 220 may be interposed between the first and second substrates 211 and 212. The barrier rib 220 and the pair of substrates 210 may partition discharge cells 295 where a discharge is to be generated. The barrier rib electrodes 230 may be arranged inside the barrier rib 220. The barrier rib 220 may be made of a dielectric substance, and may prevent the barrier rib electrodes 230 from sending a current therebetween and from being damaged due to collisions between charge particles and the barrier rib electrodes 230, may induce charged particles and may accumulate wall charges. The dielectric substance may be PbO, B₂O₃, SiO₂, etc.

The barrier rib 220 may have a sheet structure may be inserted between the first substrate 211 and the second substrate 212. Since the barrier rib 220 is the same as the first barrier rib 120 of the previous embodiment of the present invention, the description of the sheet structure is omitted.

In the present embodiment, portions surrounding the discharge cells 295 partitioned by the barrier rib 220 are circular, but may be in the shape of a polygon, e.g., a triangle, a pentagon, etc., or an oval.

The sides of the barrier rib 220 contacting the discharge cells 295 may be covered with protection layers 220a. The protective layers 220a may be formed of MgO, and may prevent the barrier rib 220 from being damaged due to sputtering of plasma particles, may discharge secondary electrons, and may reduce a discharge voltage.

The barrier rib electrodes 230 may include discharge parts 231, contact parts 232, and intermediate parts 233. The discharge parts 231 may be arranged inside the barrier rib 220 to perform a discharge and may surround the discharge cells 295.

Referring to FIG. 10, the discharge parts 231 of the barrier rib electrodes 230 may surround the discharge cells 295, and may include loop parts 231a and loop connection parts 231b.

In the present embodiment, the discharge parts 231 of the barrier rib electrodes 230 may include the circular loop parts 231a, but the present invention is not necessarily restricted thereto. That is, portions surrounding the discharge cells 295 of the discharge parts 231 may be in the shape, e.g., of an oval, polygon, or “C” shaped.

The barrier rib electrodes 230 of the present embodiment may form a three-electrode type PDP. In detail, the barrier rib electrodes 230 may include three electrode lines in a vertical order in which a center electrode line crosses other two electrode lines, thereby performing an addressing function.

The contact parts 232 may be arranged in the bottom edges of the barrier rib 220 and may have convex cross-sections. Referring to FIG. 9, the contact parts 232 may have convex cross sections electrically contacting the terminal electrodes 240. The intermediate parts 233 may electrically connect the discharge parts 231 and the contact parts 232, and may be arranged inside the barrier rib 220. The terminal electrodes 240 may each have one end electrically connected to the contact parts 232 and another end electrically connected to the signal transmitting member 250. The terminal electrodes may be arranged on the second substrate 212.

The signal transmitting member 250 may be electrically connected to an operating circuit substrate (not shown) that operates the PDP 200, and may be a FPC or a TCP. The signal transmitting member 250 may be formed of conductive wires 251 that transfer an electrical signal. The conductive wires 251 may be electrically connected to the terminal electrodes 240 and may be spaced apart by a predetermined gap. The conductive wires 251 of the signal transmitting member 250 may be connected to the terminal electrodes 240, e.g., via an anisotropic conductive film.

The first substrate 211 may include recess parts 211a, and the phosphor layer 260, in accordance with the red, green, and blue discharge cells 295, may be disposed within the recess parts 211a. The phosphor layers 260 may generate a visible light in response to ultraviolet rays. The phosphor layers 260 may be the same as the phosphor layers 190 of the previous embodiment of the present invention, so the description of the phosphor is omitted.

A frit 298 may be provided between the first substrate 211 and the barrier rib 220, and between the second substrate 212 and the barrier rib 220. The frit 298 may seal the PDP 200, e.g., using a plastic process. After the PDP 200 is sealed, a discharge gas, e.g., Ne, Xe, or a mixture thereof, may fill the discharge cells 295 of the PDP 200.

Functions and manufacturing operations of the PDP 200 according to the present embodiment will now be described in detail.

After the manufacturing of the PDP 200 and the injection of the discharge gas are complete, if a address voltage is applied to an electrode serving as a scan electrode and to an electrode serving as an address electrode among the barrier rib electrodes 230 from an external power source via the signal transmitting member 250, the terminal electrodes 240, and the contact parts 232, the address discharge is generated. Thus a discharge cell where a sustain discharge is to be generated is selected from the discharge cells 295.

If a sustain discharge voltage is applied to an electrode serving as the scan electrode and to an electrode serving as a common electrode among the barrier rib electrodes 230 via the signal transmitting member 250, the terminal electrodes 240, and the contact parts 232, the sustain discharge is generated due to movement of wall charges. The energy level of the discharge gas excited by the sustain discharge is reduced, thereby discharging ultraviolet rays.

The ultraviolet rays excite the phosphor layers 260 in the discharge cells 295. The energy level of the excited phosphor layers 260 may be reduced to discharge visible light. The visible light may be transmitted through the first substrate 211 and may form an image to be recognized by a user.

The contact parts 232 having the convex cross-sections may contact the terminal electrodes 240, thereby avoiding an erroneous connection between electrodes.

In particular, when the barrier rib 220 has the sheet structure, dielectric projections having a certain height, like the projections S1 and S2 of the previous embodiment of the present invention, may be present. The barrier rib 220 may be spaced apart from the second substrate 212 due to the dielectric projections. However, the contact parts 232 of the barrier rib electrodes 230 have convex cross sections, and may still be pressed on an upper part of the terminal electrodes 240, thereby electrically contacting the contact parts 232 and the terminal electrodes 240.

The discharge parts 231 of the barrier rib electrodes 230 may surround the discharge cells 295 so that the sustain discharge may be performed at every perimeter position of the discharge cells 295. Therefore, the PDP 200 of the present embodiment may have a relatively wide discharge area, thereby increasing light emitting brightness and light emitting efficiency.

The barrier rib 220 may be formed of sheets, including stacked dielectric substances and electrodes, and having holes defining a space where a discharge is to be generated, the manufacturing process may be simplified and the manufacturing costs may be reduced.

The phosphor layers 260 of the PDP 200 may be disposed in recess parts 211a of the first substrate 211 corresponding to the discharge cells 295 by coating phosphor on the recess parts 211a, thereby extending the discharge spaces of the discharge cells 295 and increasing light emitting efficiency.

As described above, contact parts of barrier rib electrodes may have a convex shape, so that the contact parts can electrically contact connection electrodes or terminal electrodes, even when the barrier rib in which the barrier rib electrodes are buried provides some offset between the barrier rib and a surface containing electrodes electrically connected to an external source.

Furthermore, discharge parts of barrier rib electrodes may be buried in barrier ribs and may surround discharge cells, so that the PDP of the present invention has a relatively wide discharge area, thereby increasing light emitting brightness and light emitting efficiency.

Furthermore, barrier ribs of the PDP of the present invention may be formed of sheets, thereby reducing manufacturing processes and costs.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a first substrate;
a second substrate spaced apart from the first substrate;
a barrier rib interposed between the first and second substrates, the barrier rib including passages there through defining discharge cells;
barrier rib electrodes including discharge parts adjacent to the discharge cells and inside the barrier rib, contact parts arranged on a surface of the barrier rib and having round cross-sections, and intermediate parts connecting the discharge parts to the contact parts;
terminal electrodes each having one end electrically connected to the contact parts and another end electrically connected to a signal transmitting member;
phosphor in the discharge cells; and
a discharge gas in the discharge cells.

2. The PDP as claimed in claim 1, wherein the barrier rib has a sheet structure.

3. The PDP as claimed in claim 1, wherein the surfaces of passages in the barrier rib are covered by a protective layer.

4. The PDP as claimed in claim 1, wherein the discharge parts surround at least a part of each of the discharge cells.

5. The PDP as claimed in claim 1, wherein the discharge parts are stripe-shaped.

6. The PDP as claimed in claim 1, wherein the discharge parts completely surround each of the discharge cells.

7. The PDP as claimed in claim 1, wherein the terminal electrodes are arranged on a surface of one of the first and second substrates closest to the contact parts.

8. The PDP as claimed in claim 1, wherein the barrier rib includes a first barrier rib and a second barrier rib, the first and second barrier ribs defining the discharge cells.

9. The PDP as claimed in claim 8, further comprising:
a dummy barrier rib adjacent to the second barrier rib; and
connection electrodes on the dummy barrier rib, the contact parts being electrically connected to the terminal electrodes through the connection electrodes.

10. The PDP as claimed in claim 9, wherein the dummy barrier rib includes grooves, the connection electrodes being arranged in the grooves.

11. The PDP as claimed in claim 10, wherein the second barrier rib and the dummy barrier rib are on the second substrate.

12. The PDP as claimed in claim 11, wherein an interior surface of the second substrate serves as base parts of the grooves.

13. The PDP as claimed in claim 10, wherein a length of the groove substantially equals a width of the dummy barrier rib.

14. The PDP as claimed in claim 10, wherein the connection electrodes are arranged to surround parts of the grooves of the dummy barrier rib.

15. The PDP as claimed in claim 8, wherein the phosphor is on surfaces of one of at least one of the first and second barrier ribs defining the discharge cell.

16. The PDP as claimed in claim 1, wherein the barrier rib is made of a dielectric material.

17. The PDP as claimed in claim 1, wherein the signal transmitting member includes a plurality of conductive wires.

18. The PDP as claimed in claim 17, wherein the signal transmitting member is a flexible printed cable.

19. The PDP as claimed in claim 17, wherein the signal transmitting member is a tape carrier package.

20. The PDP as claimed in claim 17, wherein the conductive wires of the signal transmitting member are secured to the terminal electrodes using an anisotropic conductive film.
